(19) United States
(12) Patent Application Publication
(10) Pub. No.: US 2025/0015975 A1
(43) Pub. Date: Jan. 9, 2025

(54) SAE-PK PROTECTED AP-STA MUTUAL AUTHENTICATION

(71) Applicant: APPLE INC., Cupertino, CA (US)

(72) Inventors: Yong Liu, Campbell, CA (US); Sidharth R. Thakur, San Jose, CA (US); Su Khiong Yong, Palo Alto, CA (US); Charles F. Dominguez, San Carlos, CA (US); Jarkko L. Knecht, Los Gatos, CA (US); Daniel R. Borges, San Francisco, CA (US)

(21) Appl. No.: 18/746,870

(22) Filed: Jun. 18, 2024

Related U.S. Application Data
(60) Provisional application No. 63/512,591, filed on Jul. 7, 2023.

(51) Int. Cl. H04L 9/08

(52) U.S. Cl. CPC H04L 9/0822; H04L 2209/80

(57) ABSTRACT

Embodiments herein provide systems, apparatuses, and methods for authentication of an access point and a station in a wireless local area network. An access point and station may generate a Key Encryption Key (KEK). The access point and station may send authentication credentials encrypted based on the KEK. The access point may authenticate the station by validating the station authentication credential, and the station may authenticate the access point by validating the access point authentication credential.

### CROSS-REFERENCE TO RELATED APPLICATION

This application claims the benefit of U.S. Provisional Patent Application No. 63/512,591, filed Jul. 7, 2023, which is hereby incorporated by reference herein in its entirety.

### BACKGROUND

Wireless communication technology uses various standards and protocols to transmit data between an access point and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

In the 802.11 standard for WLAN, an access point (AP) is a device that creates a wireless local area network (WLAN), or Wi-Fi® network. It may be connected to a wired network, such as an Ethernet network, and provides wireless access to that network for other devices. A station is a device that is capable of being wirelessly connected to the AP to join the WLAN network. Stations can be laptops, smartphones, tablets, or any other device with a WLAN adapter.

APs and stations communicate with each other using the Wi-Fi® protocol. Various protocols have been established to increase security over a wireless communication network. For example, Simultaneous Authentication of Equals is the core authentication protocol of WPA3-Personal, and is mandated to be supported by all Wi-Fi® Alliance certified devices, including both access points (APs) and non-AP stations (STAs).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a signal flow diagram of an SAE protocol in accordance with some embodiments.

FIG. 2 illustrates a signal flow diagram of an SAE-PK protocol in accordance with some embodiments.

FIG. 3 illustrates a chart of some solutions to provide per-STA authentication in accordance with some embodiments.

FIG. 4 illustrates a simplified block diagram of different per-STA authentication techniques in accordance with some embodiments.

FIG. 5 illustrates a signal flow diagram of an SAE-PK method for authentication with additional modifications for improving the SAE-PK method in accordance with some embodiments.

FIG. 6 illustrates a signal flow diagram for SAE-PK protected authentication credential provisioning in accordance with some embodiments.

FIG. 7 illustrates a signaling diagram for an STA and AP using a self-signed certificate based authentication credential in accordance with some embodiments.

FIG. 8 illustrates a signaling diagram and a networking diagram for a WLAN that uses multiple APs using a self-signed certificate based authentication credential in accordance with some embodiments.

FIG. 9 illustrates a signaling diagram and a networking diagram for a WLAN that uses public key based authentication credential in accordance with some embodiments.

FIG. 10 illustrates a signaling diagram and a networking diagram for a WLAN that uses multiple APs using a connector based authentication credential in accordance with some embodiments.

FIG. 11 illustrates a flow chart for SAE-PK password generation in accordance with some embodiments.

FIG. 12 illustrates a JSON web signature (JWS) payload for a DPP connector in accordance with some embodiments.

FIG. 13 illustrates a system for performing signaling between a wireless device and a network device, according to embodiments disclosed herein.

### DETAILED DESCRIPTION

Wireless communication technology uses various standards and protocols to transmit data between an access point and a wireless communication device. One standard that is used for wireless communication is Institute of Electrical and Electronics Engineers (IEEE) 802.11 standard for Wireless Local Area Networks (WLAN) (commonly known to industry groups as Wi-Fi®). Wi-Fi® provides a convenient way to establish a network between devices. A device may connect to a Wi-Fi® access point to join a network and connect to the internet wirelessly. Wi-Fi® security is important to protect data and devices from unauthorized access.

One method to establish a secure network includes the use of Simultaneous Authentication of Equals (SAE). SAE is a core authentication protocol of WPA3-Personal, and is mandated to be supported by all Wi-Fi® Alliance certified devices, including both access points (APs) and non-AP stations (STAs). SAE is a Password-Authenticated Key Exchange (PAKE) protocol. That means that SAE relies on a password to bootstrap trust between two devices.

All non-AP STAs use the same password to authenticate with an AP. The use of the same password comes with security vulnerabilities. For example, a Wi-Fi® password can be easily accessed in many public Wi-Fi® hotspot scenarios. For instance, a password to a public Wi-Fi® network may be displayed on a sign. Once an intruder knows the Wi-Fi® password of an AP, the intruder can launch an evil twin AP using same service set identifier (SSID) and password. The evil twin AP may then allure non-AP STAs to join the evil twin AP. With SAE, the non-AP STAs have no way to authenticate the AP.

Another authentication protocol is SAE-Public Key (PK). SAE-PK provides protection against evil twin attacks on client devices in public networks. SAE-PK was defined in the WPA3 R3 standard to allow an AP to: 1) generate a public and private key pair; 2) generate a SAE password as a fingerprint of the public key. During SAE authentication, the AP provides its public key to a non-AP STA, which enables the non-AP STA to match the SAE password with the public key, therefore, verifying that the AP is not an evil twin AP. The AE-PK provides a strong means for an AP to authenticate itself, based on the SAE authentication protocol.

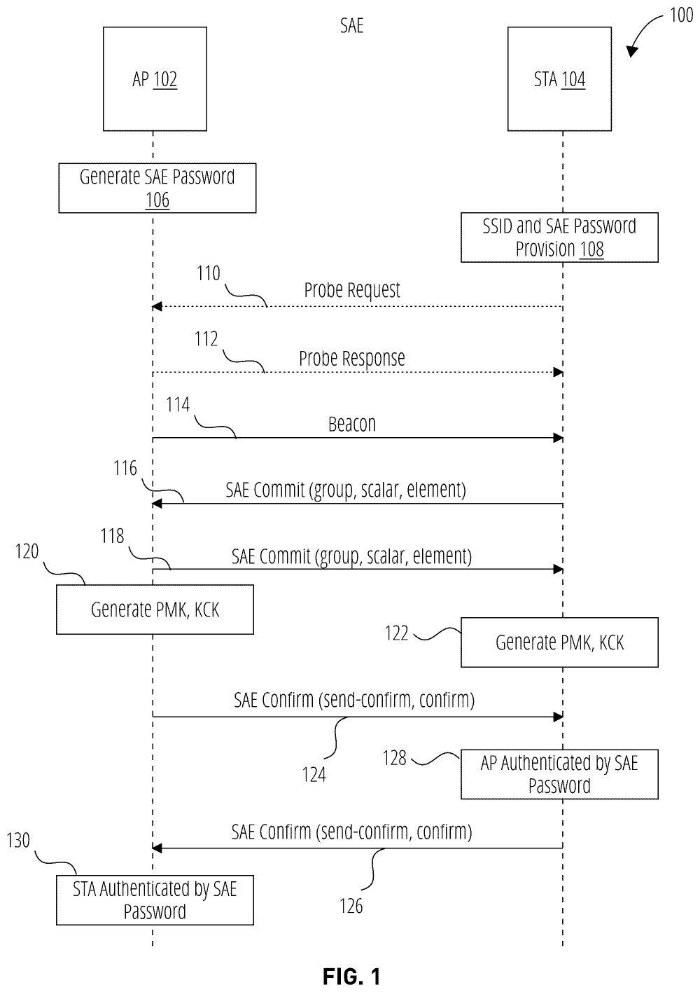

FIG. 1 illustrates a signal flow diagram 100 of an SAE protocol in accordance with some embodiments. As shown, the AP 102 may generate 106 a SAE password. The STA 104 may be provisioned 108 with a service set identifier (SSID) and SAE password corresponding to the AP 102.

In some embodiments, the STA 104 may send the AP 102 a probe request 110 to initiate the authentication process. The AP 102 may send a probe response 112. The probe response 112 may include supported security protocols for the AP 102. In some embodiments, the AP 102 may send a beacon 114 to the STA 104. The beacon 114 may be sent periodically to advertise the presence and capabilities of the AP 102. The beacon 114 may include the SSID, supported security protocols, and the group that the AP 102 is using.

The STA 104 sends a SAE commit message 116 to the AP 102 and the AP sends a commit message 118 to the STA 104. In the commit exchange, both parties may exchange group, scalar, and an element field data. The AP 102 and the STA 104 generate a Pairwise Master Key (PMK) and a Key Confirmation Key (KCK) (e.g., PMK, KCK 120 and PMK, KCK 122) from a shared secret. The AP 102 may send an SAE confirm message 124 to the STA 104, and the STA 104 can send an SAE confirm message 126 to the AP 102. Each of the confirm messages may include a confirm field with a value that may be used by the receiving device to confirm both the AP 102 and the STA 104 are using the same keys.

The STA 104 may authenticate 128 the AP 102 by the SAE password. The AP 102 may authenticate 130 the STA 104 by the SAE password. In other words, the AP 102 and the STA 104 authenticate each other based on the SAE password.

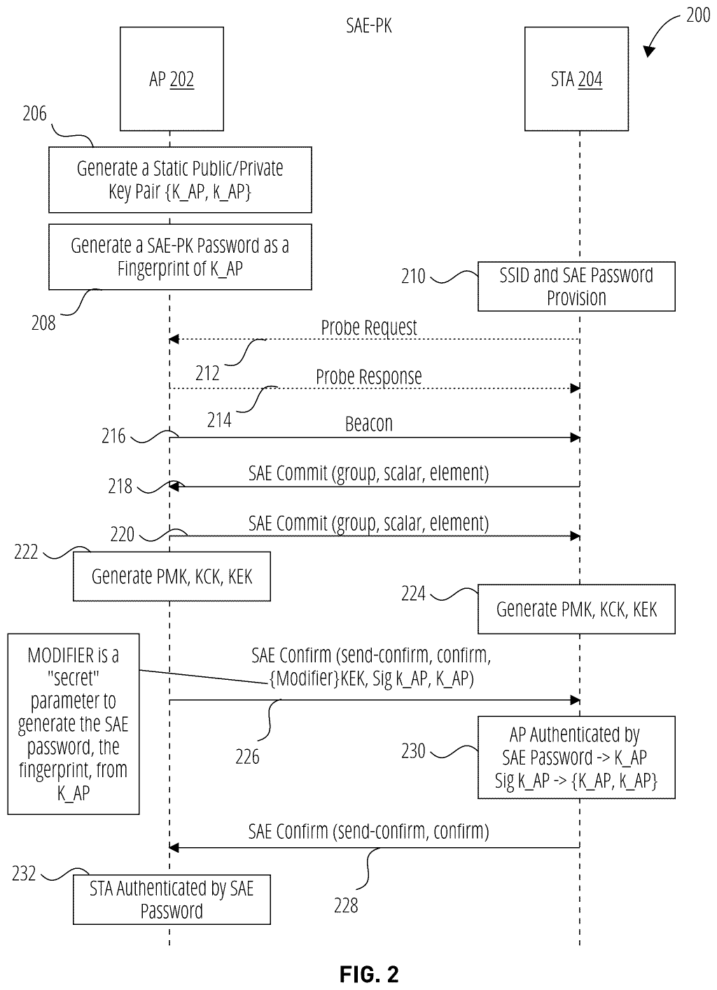

FIG. 2 illustrates a signal flow diagram 200 of an SAE-PK protocol in accordance with some embodiments. As shown, the AP 202 may generate 206 a static public/private key pair, and may generate 208 a SAE-PK password as a fingerprint of the static public/private key pair. The STA 204 may be provisioned 210 with a SSID and SAE password corresponding to the AP 202.

In some embodiments, the STA 204 may send the AP 202 a probe request 212 to initiate the authentication process. The AP 202 may send a probe response 214. The probe response 214 may include supported security protocols for the AP 202. In some embodiments, the AP 202 may send a beacon 216 to the STA 204. The beacon 216 may be sent periodically to advertise the presence and capabilities of the AP 202. The beacon 216 may include the SSID, supported security protocols, and the group that the AP 202 is using.

The STA 204 sends a SAE commit message 218 to the AP 202 and the AP 202 may send a commit message 220 to the STA 204. In the commit exchange, both parties may exchange group, scalar, and an element field data. The AP 202 and the STA 204 generate a Pairwise Master Key (PMK), a Key Confirmation Key (KCK), and a Key Encryption Key (KEK) (e.g., PMK, KCK, KEK 222 and PMK, KCK, KEK 224) from a shared secret. The AP 202 may send an SAE confirm message 226 to the STA 204. The SAE confirm message 226 may include a confirm field and a modifier that is a secret parameter to generate the SAE password (e.g., the fingerprint from the public/private key pair). The modifier may be protected by the KEK. The SAE confirm message 226 may also include the AP 202's public key generated at 206, and a signature generated by AP 202's private key generated at 206. The STA 204 can send an SAE confirm message 228 to the AP 202. The SAE confirm message 228 may include a confirm field with a value that may be used by the receiving device that the STA 204 is using the same key as the AP 102 and the STA 104 are using the same keys.

As is shown, the AP 202 authenticates 232 the STA 204 based on an SAE password, and the STA 204 authenticates 230 the AP 202 based on both the SAE password and the AP's public/private key pair. The SAE-PK provides strong authentication from the AP side. However, the STA side authentication still relies on the SAE password, which is shared to all STAs authorized to associate to the AP 202. There are more and more Wi-Fi® use cases which require strong per-STA authentication. For example, in some Wi-Fi® networks, an AP (or mesh AP system) needs to differentiate/authenticate different associating devices, in order to assign the devices to different virtual local area networks (VLANs), or provide different types of services.

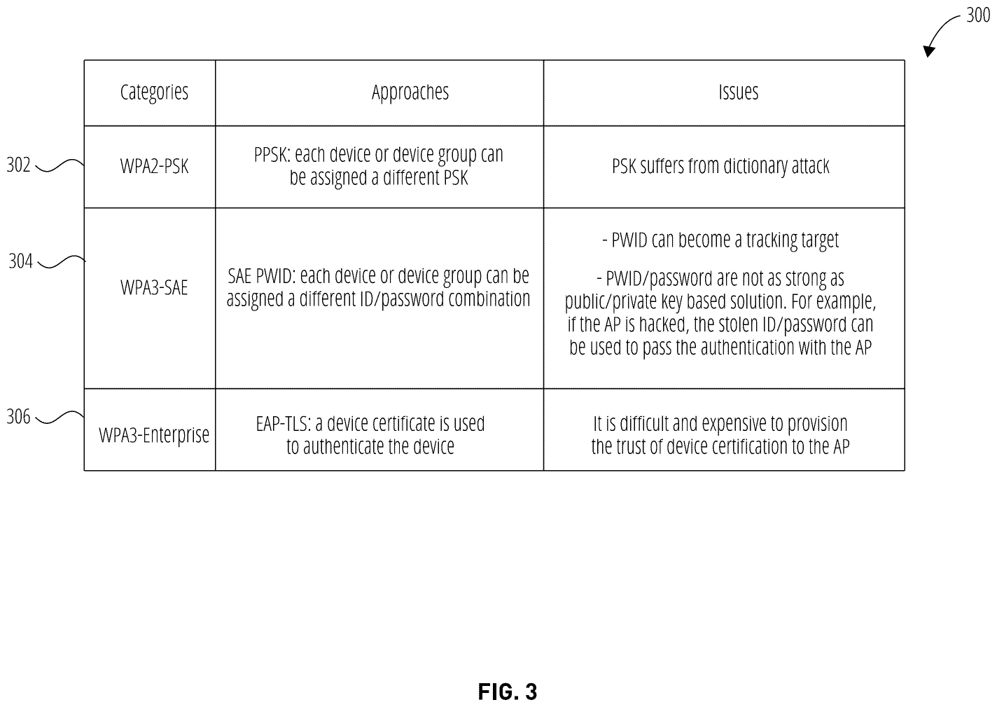

FIG. 3 illustrates a chart 300 of some solutions to provide per-STA authentication. In a system that uses WPA2-PSK 302, each device or device group can be assigned a different pre-shared key (PSK). However, PSK suffers from a dictionary attack.

In a system that uses WPA3-SAE 304, each device or device group can be assigned a different ID/password combination. However, the password ID can become a tracking target. Further, the ID/password may not be as strong as a public/private key based solution. For example, if the AP is hacked, the stolen ID/password can be used to pass the authentication with the AP.

In a system that uses WPA3-Enterprise 306, a device certificate is used to authenticate the device. However, it is difficult and expensive for an AP to obtain the trust of device certificates and maintain the device certificates.

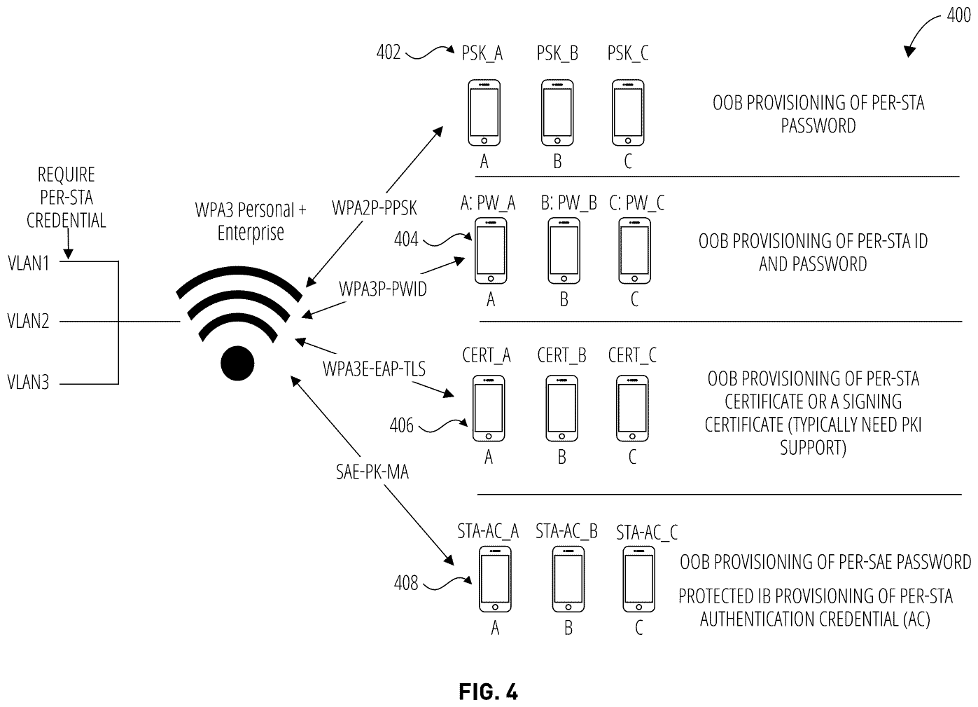

FIG. 4 illustrates a simplified block diagram 400 of different per-STA authentication techniques. As shown, in WPA2P-PPSK 402, each station may be assigned a different PSK. WPA2P-PPSK 402 may use out of band (OOB) provisioning of the per-STA password. As previously discussed, this method may be susceptible to a dictionary attack. WPA3P-PWID 404 may employ OOB provisioning for the ID and password for each station. Implementing this may be difficult, as it would require changes to current systems. For example, a device may be requested for both an ID and a password, and currently only a password is required for many networks. WPA3E-EAP-TLS 406 may use OOB provisioning of per-STA certificate or a signing certificate. The certificates typically need PKI support. The certificate may be expensive to maintain.

Embodiments herein may implement the SAE-PK-MA 408 technique to alleviate some of the problems discussed with the above per-STA credential approaches. The SAE-PK-MA 408 approach may use OOB provisioning of per-SAE password. Additionally, the SAE-PK-MA 408 approach may use protected inbound (IB) provisioning of per-STA authentication credential.

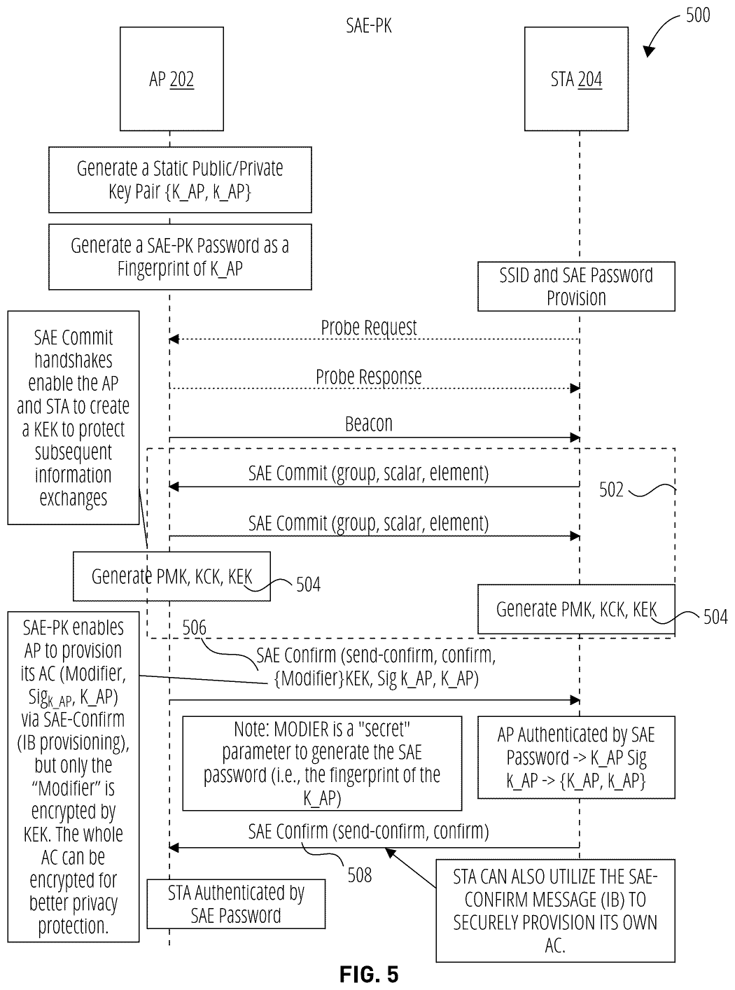

FIG. 5 illustrates a signal flow diagram 500 of an SAE-PK method for authentication (as described with reference to FIG. 2) with additional modifications for improving the SAE-PK method. The SAE commit handshake 502 may include a SAE commit message from both the STA 204 and the AP 202. The SAE commit messages may include a group, scalar, and element.

The SAE commit messages may be used to enable the AP 202 and the STA 204 to create a KEK 504 to protect subsequent information exchanges. Currently SAE-PK only uses KEK 504 to protect the modifier 506 of the SAE confirm message from the AP 202. The modifier is a “secret” parameter to generate the SAE password (i.e., the fingerprint of the K_AP). SAE-PK enables AP 202 to provision its authentication credentials (AC) (Modifier, Sig_{k_AP}, K_AP) via SAE-Confirm (IB provisioning), but only the “Modifier” is encrypted by KEK. An improvement may be made to the security using the KEK. In fact, the whole AC can be encrypted for better privacy protection. Additionally, in some embodiments, the STA 204 can also utilize the SAE-Confirm message 508 (e.g., an IB message) to securely provision its own AC.

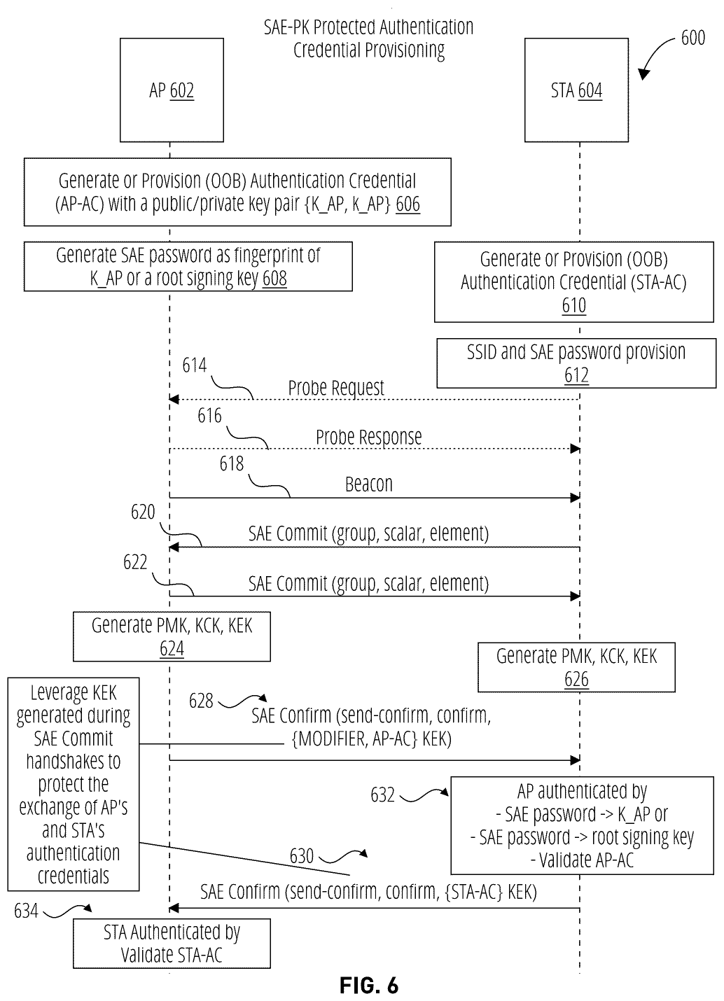

FIG. 6 illustrates a signal flow diagram 600 for SAE-PK protected authentication credential provisioning. In the illustrated embodiment, SAE-PK is extended to enable secured in-band provisioning of authentication credentials (ACs) between an AP 602 and an STA 604. The in-band provisioning may occur when the STA 604 establishes first-time authentication with the AP 602, or when the AC from either side is revoked or updated.

For example, the AP 602 may generate 606 or be provisioned with (e.g., via OOB signaling) an authentication credential (AP-AC) with a public/private key pair (K_AP, k_AP). The AP-AC, including the public/private key pair, may be used to authenticate the AP. Some AP-AC material, such as the public key, is made available to a device (e.g., STA 604) who possesses the AP's SAE password, and wants to connect to the network, while the private key is kept secret by the AP 602.

The AP-AC can include one or multiple of following parameters. In some embodiments, the AP-AC may include an AP identifier (a short ID). The AP identifier may include a service set identifier/Basic Service Set Identifier (SSID/BSSID), an Identity Resolving Key (IRK) (e.g. for mobile AP identity protection), or other formats of AP ID (e.g. a hash of K_AP), or signed AP ID.

In some embodiments the AP-AC may include an authentication key. In some embodiments, the authentication key may include a self-signed public key (K_AP), with a corresponding private key. In some embodiments, the authentication key may include a self-signed certificate, with a corresponding private key. In some embodiments, the authentication key may include a certificate signed by a root, with a root signing key pair. In some embodiments, the authentication key may include a device provisioning protocol (DPP) connector signed by a configurator, with a configurator signing key pair. The DPP connector may be a simplified certificate defined by Wi-Fi Easy Connect™. In some embodiments the AP-AC may include an AP-AC fingerprint (i.e. the SAE password). For example, the AP-AC may include fingerprint generation parameters (e.g. the “modifier” sent in the SAE confirm message). The AP 602 may generate 608 an SAE password as a fingerprint of K_AP or a root signing key.

The STA 604 may also generate 610 or be provisioned with (e.g., via OBB signaling) its own authentication credential (STA-AC). The STA-AC can include one or multiple of the following options. In some embodiments, the STA-AC may include an STA identifier (e.g., a short ID). The STA identifier may include an IRK. In some embodiments, the STA identifier may include other formats of STA ID or signed STA ID such as a hash of a public key of the STA 604 (K_STA), or an STA-AC fingerprint and corresponding fingerprint generation parameters e.g. the “modifier.”

In some embodiments, the STA-AC may include an authentication key. In some embodiments, the authentication key may include a self-signed public key (K_STA), with a corresponding private key. In some embodiments, the authentication key may include a self-signed certificate, with a corresponding private key. In some embodiments, the authentication key may include a certificate signed by a root, with a root signing key pair. In some embodiments, the authentication key may include a DPP connector signed by a configurator, with a configurator signing key pair. The STA 604 may be provisioned 612 with the SSID and the SAE password corresponding to the AP 602.

In some embodiments, the STA 604 may send the AP 602 a probe request 614 to initiate the authentication process. The AP 602 may send a probe response 616. The probe response 616 may include supported security protocols for the AP 602. In some embodiments, the AP 602 may send a beacon 618 to the STA 604. The beacon 618 may be sent periodically to advertise the presence and capabilities of the AP 602. The beacon 618 may include the SSID, supported security protocols, and the group that the AP 602 is using.

The STA 604 and the AP 602 may perform an SAE commit exchange. The STA 604 sends a SAE commit message 620 to the AP 602, and the AP 602 may send a commit message 622 to the STA 604. In the commit exchange both parties may exchange group, scalar, and an element to generate a key that is used to encrypt subsequent communications between the AP 602 and the STA 604.

The AP 602 and the STA 604 generate a PMK, a KCK, and a KEK (e.g., PMK, KCK, KEK 624 and PMK, KCK, KEK 626). The AP 602 may send an SAE confirm message 628 to the STA 604. The SAE confirm message 628 may include a confirm field, a modifier, and the AP-AC. The modifier and the AP-AC may be protected by the KEK. The modifier and the AP-AC may be stored by the STA 604 and used to authenticate the AP 602. The AP 602 may leverage the KEK generated during the SAE commit handshakes to protect the exchange of the AP's authentication credentials. For instance, the AP-AC and the modifier may be encrypted by the AP 602 using the KEK. The encryption may increase privacy of the AP-AC information, this may be particularly useful for protecting the identity of mobile AP's.

The STA 604 may authenticate 632 the AP 602 using a variety of parameters. For example, the STA 604 may authenticate 632 the AP 602 based on the AP's public key K_AP or a root signing key. For example, the STA 604 may verify that the K_AP or root signing key corresponds to the SAE password. In some embodiments, the STA 604 may authenticate 632 the AP 602 by validating the AP-AC. The STA 604 may decrypt the AP-AC and confirm that the AP-AC corresponds with the AP 602.

The STA 604 can send an SAE confirm message 630 to the AP 602. The SAE confirm message 630 may include a confirm field and the STA-AC. The STA 604 may leverage the KEK generated during the SAE commit handshakes to protect the exchange of the STA's authentication credentials. For instance, the AP-AC may be encrypted by the STA 604 using the KEK. The AP 602 may authenticate 634 the STA 604 by validating the STA-AC. For instance, the AP 602 may decrypt the STA-AC and confirm that the STA-AC corresponds with the STA 604. This may provide a strong per-STA authentication. For example, in some Wi-Fi® networks, an AP (or mesh AP system) may be able to use the STA-AC to differentiate/authenticate different associating devices, in order to assign the devices to different virtual local area networks (VLANs), or provide different types of services. Both AP-AC and STA-AC are encrypted during provisioning for better privacy protection.

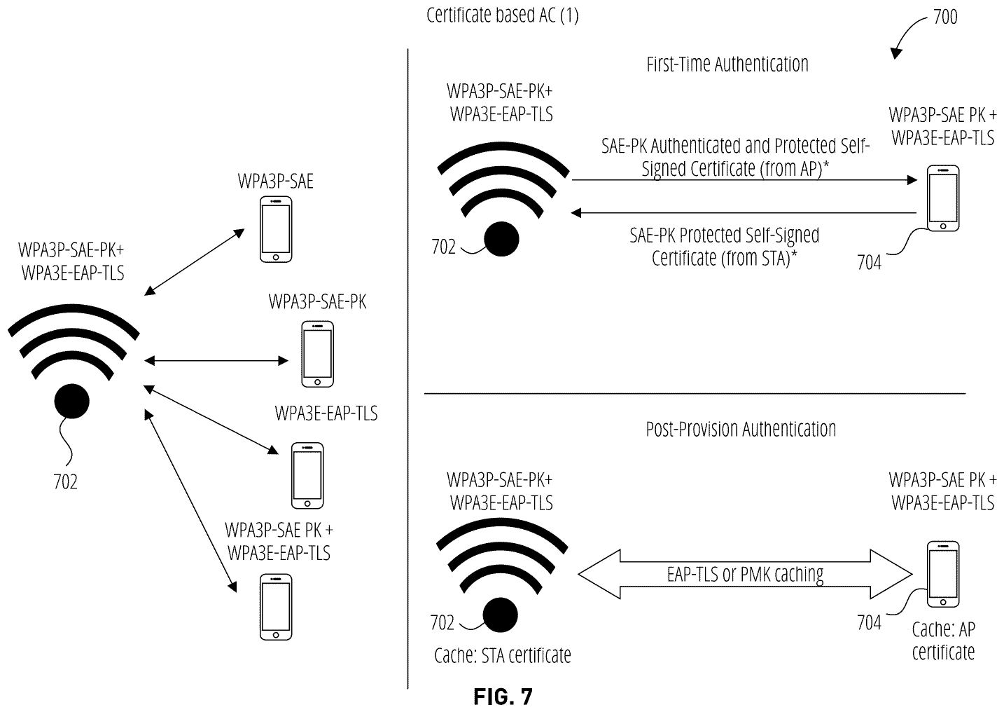

FIG. 7 illustrates a signaling diagram 700 for an STA 704 and AP 702 using a self-signed certificate based authentication credential. Specifically, the illustrated embodiment provides details regarding first-time authentication and post-provision authentication when a self-signed certificate is used for SAE-PK authentication credential provisioning as discussed with reference to FIG. 6.

As shown, an AP 702 may support both WPA3 personal SAE-PK (WPA3P-SAE-PK) and WPA3 enterprise Extensible Authentication Protocol-Transport Layer Security (WPA3E-EAP-TLS). The AP 702 may connect to stations that support one of WPA3P-SAE, WPA3P-SAE-PK, WPA3E-EAP-TLS, or WPA3P-SAE-PK+ WPA3E-EAP-TLS. In the signaling diagram 700, the STA 704 supports WPA3P-SAE-PK+ WPA3E-EAP-TLS.

As explained with reference to FIG. 6, during the SAE-PK protected authentication credential provisioning procedure, both the AP 602 and the STA 604 provide each other with authentication credentials. In the embodiment shown in FIG. 7, the AP 702 and the STA 704 use a self-signed certificate for the authentication credit.

During a first time authentication, the AP 702 and the STA 704 exchange self-signed certificates. The AP 702 sends the STA 704 a self-signed certificate during the SAE commit message. The STA 704 may store the self-signed certificate from the AP 702. The STA 704 sends the AP 702 a self-signed certificate. The AP 702 may store the self-signed certificate from the STA 704. Both AP 702 and STA 704 can revoke their certificates at any time. However, if the certificates are revoked, the AP 702 and the STA 704 need to re-do SAE-PK protected provisioning to exchange new certificates.

After the self-signed certificates are exchanged, the AP 702 and the STA 704 may use post-provision authentication procedures to authenticate each other. The post-provision authentication procedures refer to authenticating an AP or STA after the authentication credentials (e.g., the self-signed certificates) have been provisioned. In post-provision authentication procedures, the AP 702 may use the stored STA self-signed certificate to authenticate the STA 704, and the STA 704 may use the stored AP self-signed certificate to authenticate the AP 702. As shown, the post-provisioning authentication procedure may include EAP-TLS or PMK caching. If PMK caching is used, the AP certificate and STA certificate can be securely exchanged and verified during 4-Way handshakes. The AP 702 and STA 704 can also exchange AP ID and STA ID signed by the private keys associated with their certificates during the 4-Way handshakes.

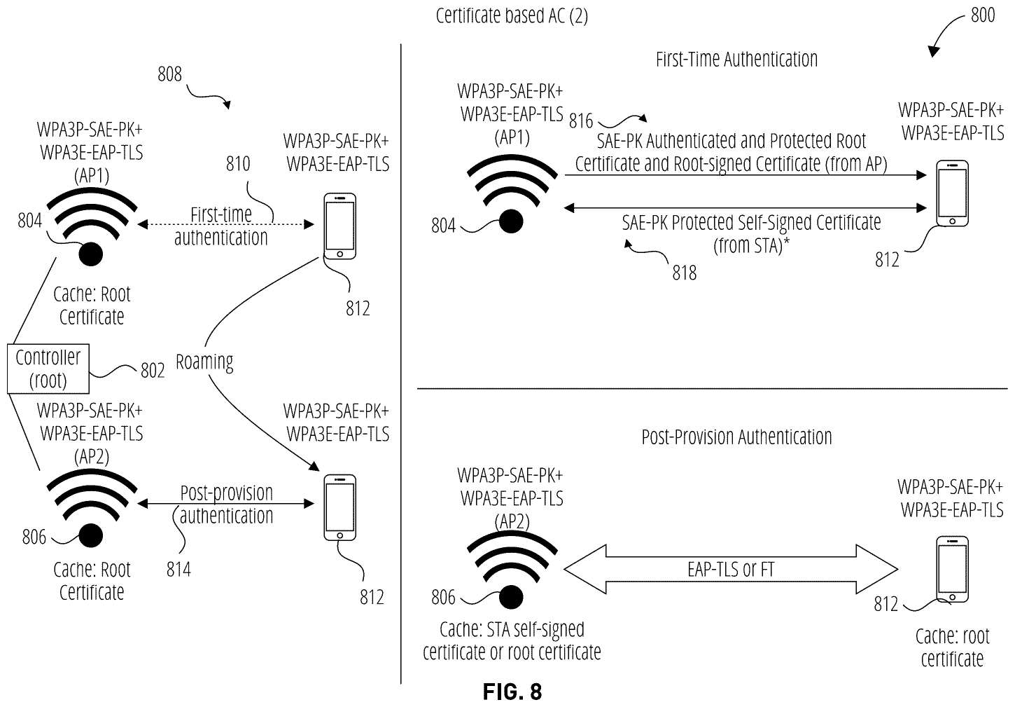

FIG. 8 illustrates a signaling diagram 800 and a networking diagram 808 for a WLAN that uses multiple APs using a self-signed certificate based authentication credential. Specifically, the illustrated embodiment provides details regarding first-time authentication and post-provision authentication when a self-signed certificate is used for SAE-PK authentication credential provisioning as discussed with reference to FIG. 6.

As shown, the first AP 804 and the second AP 806 may support both WPA3P-SAE-PK and WPA3E-EAP-TLS. The first AP 804 may perform a first-time authentication procedure 810 with the STA 812. Subsequent authentications performed on the first AP 804 may rely on a post-provision authentication procedure. If the first AP 804 is configured to be in a same network (e.g., same SSID and password) with multiple APs (e.g., second AP 806) it may save resources if the other APs also relies on the post-provision authentication procedure 814. Accordingly, a controller 802 may be used to provide unifying certificates to each of the APs to allow the STA 812 to roam freely between the first AP 804 and the second AP 806.

The controller 802 may have its own certificate (e.g., the root certificate). The controller 802 may provide the first AP 804 and the second AP 806 with the root certificate. Both the first AP 804 and the second AP 806 may store the root certificate and use the root certificate for authentication procedures. If the whole extended service set (ESS) or mobility domain uses the same SSID and SAE password, the SAE password may be generated by using the root's signing public key (instead of individual AP's public key (K_AP)).

For example, during the first-time authentication procedure 810, the first AP 804 and the STA 812 exchange certificates. The first AP 804 may send 816 the STA 812 a SAE-PK Authenticated and Protected Root Certificate and Root-signed Certificate which the 812 may store. The STA 812 may send the first AP 804 a SAE-PK Protected Self-Signed Certificate 818, which the first AP 804 may store. Additionally, the STA self-signed certificate can be distributed to all APs. For example, the first AP 804 may share the STA Self-Signed Certificate with the controller 802 which may share it with the second AP 806. Additional handshakes can also be used for the STA to get a root-signed certificate, e.g. from the controller.

After the certificates are exchanged, the first AP 804 or the second AP 806 and the STA 812 may use post-provision authentication procedures (e.g., post-provision authentication procedure 814) to authenticate each other. In post-provision authentication procedures, the second AP 806 may use the stored STA self-signed certificate or root certificate to authenticate the STA 812, and the STA 812 may use the stored root certificate to authenticate the second AP 806. As shown, the post-provisioning authentication procedure may include EAP-TLS or fast transition (FT). If FT is used, the AP certificate and STA certificate can be securely exchanged and verified during the FT 4-Way handshakes. AP and STA can also exchange AP ID and STA ID signed by the root during the FT 4-Way handshakes.

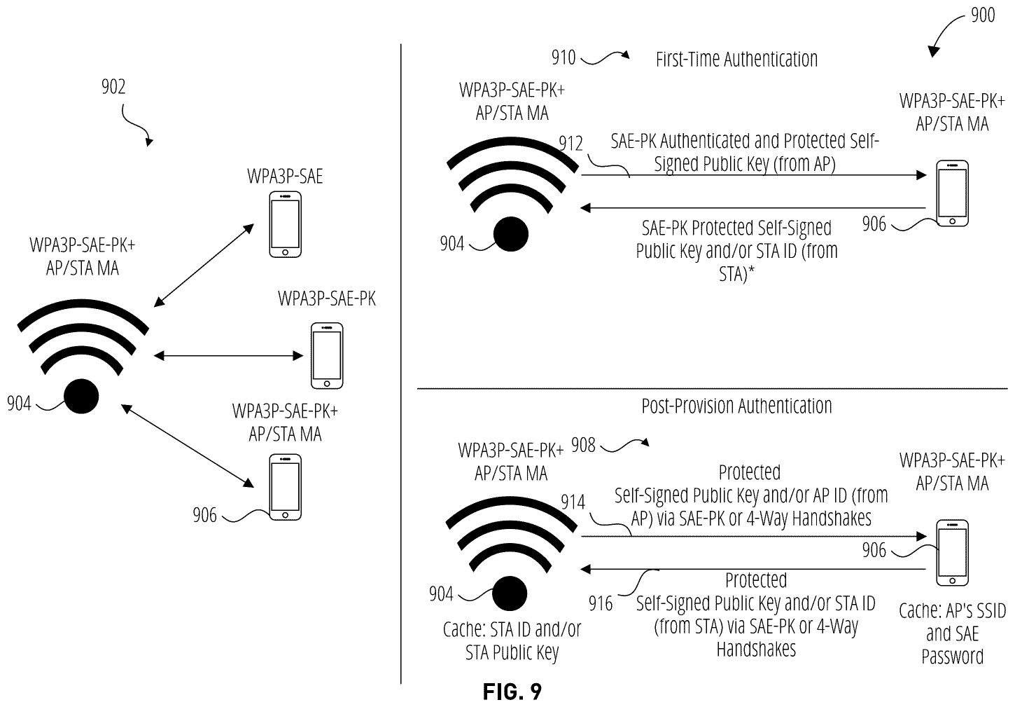

FIG. 9 illustrates a signaling diagram 900 and a networking diagram 902 for a WLAN that uses public key based authentication credential. Specifically, the illustrated embodiment provides details regarding a first-time authentication procedure 910 and post-provision authentication procedure 908 when a public key based authentication credential provisioning as discussed with reference to FIG. 6.

As shown, an AP 904 may support both WPA3P-SAE-PK and AP/STA MA. The AP 904 may connect to stations that support one of WPA3P-SAE, WPA3P-SAE-PK, or WPA3P-SAE-PK+ AP/STA MA. In the signaling diagram 900, the STA 906 supports WPA3P-SAE-PK+ AP/STA MA.

During the first-time authentication procedure 910, the AP 904 and the STA 906 exchange self-signed public keys. The AP 904 may send the STA 906 a SAE-PK Authenticated and Protected Self-Signed Public Key 912. The STA 906 may send the AP 904 a SAE-PK Protected Self-Signed Public Key and/or STA ID. The AP 904 may store the STA ID and/or the STA public key. The STA ID can be a short fingerprint of the STA public key, like the SAE password as a fingerprint of the AP public key. Caching a short STA ID, instead of a long STA public key, can reduce the storage burden at the AP. The STA 906 may store the SSID and SAE password of the AP.

After the first-time authentication procedure 910, the AP 904 and the STA 906 may use a post-provision authentication procedure 908. In the illustrated embodiment, the AP 904 may send the STA 906 a protected self-signed public key and/or AP ID (from AP) via SAE-PK or 4-Way handshakes 914. The STA 906 may verify the protected self-signed public key and/or AP ID based on the SSID and the SAE password. The STA 906 may send the AP 904 a protected self-signed public key and/or AP ID (from STA) via SAE-PK or 4-Way handshakes 916. The STA 906 may send the AP 904 a protected self-signed public key and a corresponding modifier if the AP 904 stores the STA ID only. The AP 904 may use the STA ID and/or the STA public key to verify the received protected signed public key and/or AP ID.

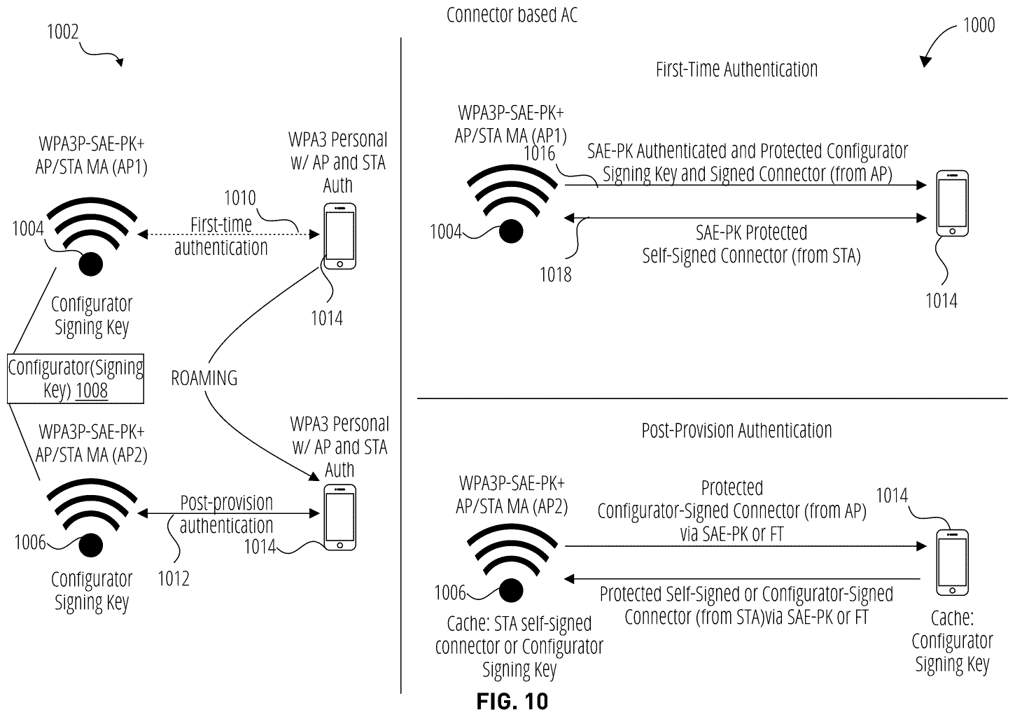

FIG. 10 illustrates a signaling diagram 1000 and a networking diagram 1002 for a WLAN that uses multiple APs using a connector based authentication credential. Specifically, the illustrated embodiment provides details regarding first-time authentication and post-provision authentication for SAE-PK authentication credential provisioning as discussed with reference to FIG. 6.

As shown, the first AP 1004 and the second AP 1006 may support both WPA3P-SAE-PK and AP/STA MA. The first AP 1004 may perform a first-time authentication procedure 1010 with the STA 1014. Subsequent authentications performed on the first AP 1004 or the second AP 806 may rely on a post-provision authentication procedure 1012. The first AP 1004 and the second AP 1006 may be configured with the same SSID and password.

A configurator 1008 may be used to provide unifying certificates to each of the APs to allow the STA 1014 roam freely between the first AP 804 and the second AP 806. The configurator 1008 may have its own signing key (e.g., private/public key pair). The configurator 1008 may provide the first AP 1004 and the second AP 1006 with the signing key. Both the first AP 1004 and the second AP 1006 may store the signing key and use the signing key for authentication procedures. If the whole ESS or mobility domain uses the same SSID and SAE password, the SAE password is generated by using the configurator's signing public key.

For example, during the first-time authentication procedure 1010, the first AP 1004 may send the STA 1014 a SAE-PK authenticated and protected configurator signing key 1016 and signed connector. The STA 1014 may store the configurator signing key 1016. The STA 1014 may send the first AP 1004 a SAE-PK Protected self-signed connector 1018. The first AP 1004 may store the STA self-signed connector 1018 or configurator signing key for the STA 1014. STA self-signed connector can be distributed to all APs; or additional handshakes between the STA and the configurator can be conducted for the STA to provide a connector to the configurator and get a configurator-signed connector (or STA ID) from the configurator.

In the post-provision authentication procedure 1012, the second AP 1006 may use the stored STA self-signed connector 1018 or configurator signing key to authenticate the STA 1014, and the STA 1014 may use the stored configurator signing key to authenticate the second AP 1006. As shown, the post-provisioning authentication procedure may include the second AP 1006 sending the STA 1014 a protected configurator-signed connector, and the STA 1014 sending the second AP 1006 a protected self-signed or configurator-signed connector via SAE-PK or FT. This information along with the information stored from the first-time authentication procedure 1010 may be used to authenticate both the second AP 1006 and the STA 1014.

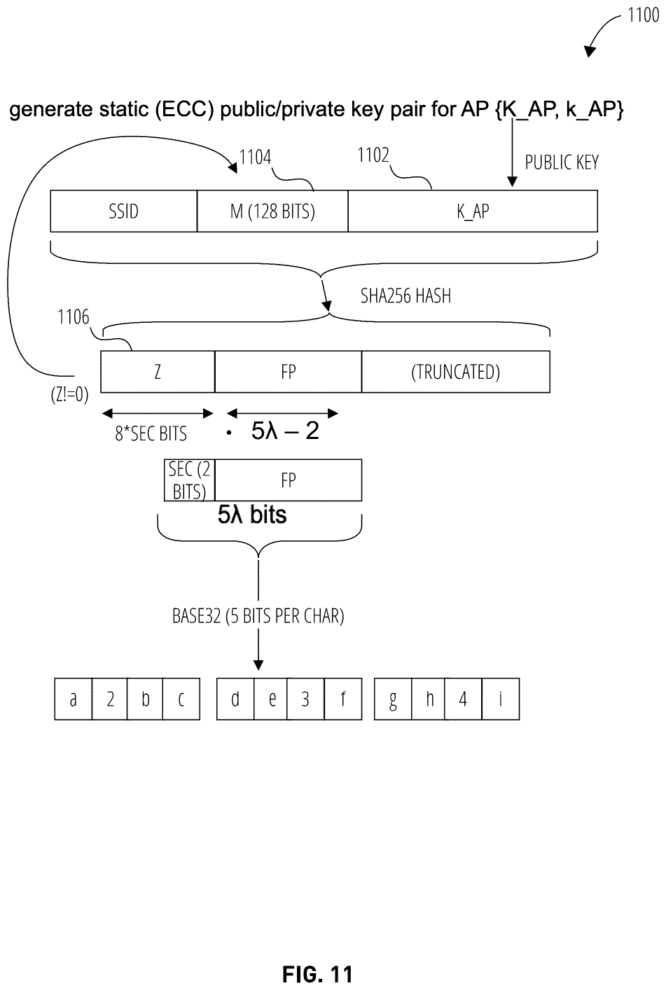

FIG. 11 illustrates a flow chart 1100 for SAE-PK password generation in accordance with some embodiments. The hash extension may be based on RFC 3972. The input to hash function may be modified by prepending the public key (K_AP 1102) with a 128-bit Modifier (M 1104). M 1104 may be randomly found by a (brute force) search such that the first 8*Sec bits (Z 1106) of the hash output are equal to zero. The search time complexity=O(2^{8*Sec}), where Sec∈{2, 3, 4, 5}. The second preimage strength of fingerprint: N=(8*Sec+5λ−2) bits.

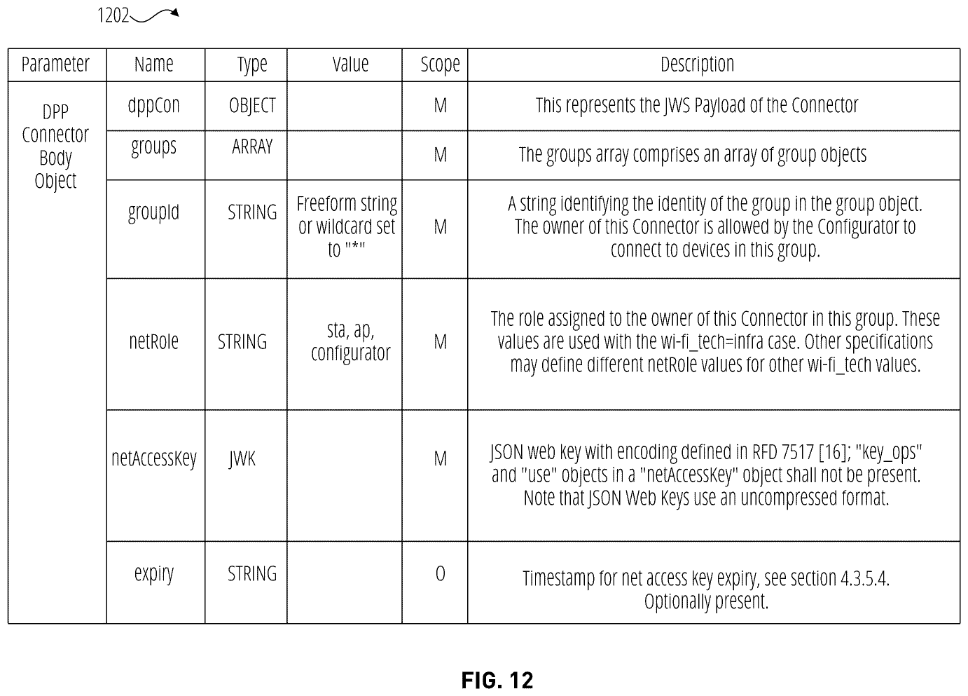

FIG. 12 illustrates a JSON web signature (JWS) payload 1202 for a DPP connector in accordance with some embodiments. The Configurator may possess a signing key pair (c-sign-key, C-sign-key). The c-sign-key may be used by the Configurator to sign Connectors. The C-sign-key may be used by provisioned devices to verify Connectors of other devices are signed by the same Configurator.

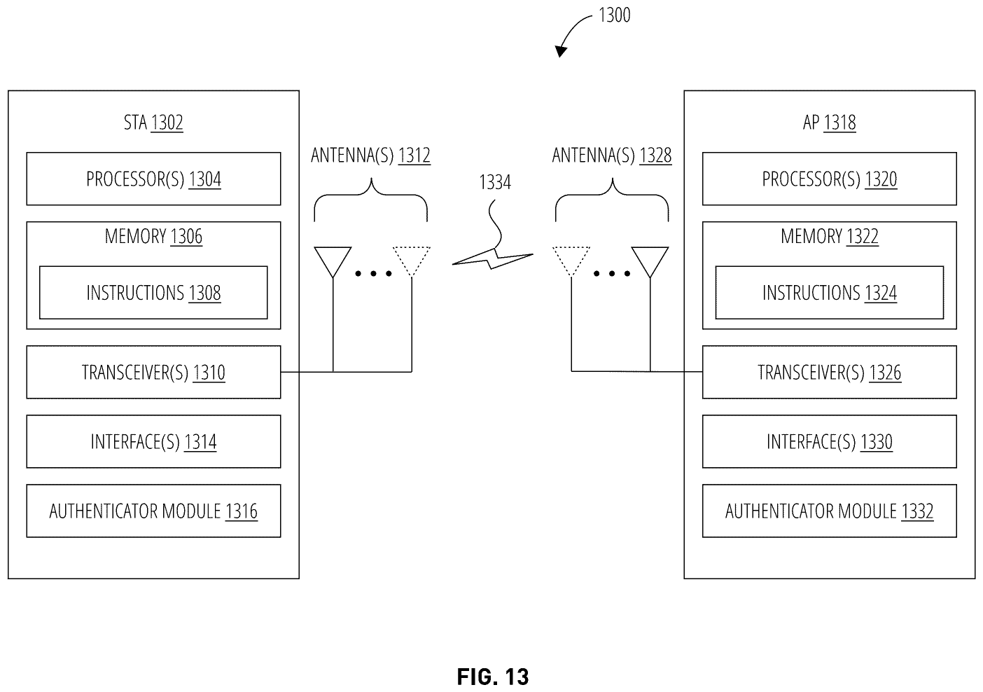

FIG. 13 illustrates a system 1300 for performing signaling 1334 between a STA 1302 and an AP 1318, according to embodiments disclosed herein. The system 1300 may be a portion of a wireless communications system as herein described. The STA 1302 may be, for example, a UE of a wireless communication system. The AP 1318 may be, for example, an access point of a wireless communication system.

The STA 1302 may include one or more processor(s) 1304. The processor(s) 1304 may execute instructions such that various operations of the STA 1302 are performed, as described herein. The processor(s) 1304 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The STA 1302 may include a memory 1306. The memory 1306 may be a non-transitory computer-readable storage medium that stores instructions 1308 (which may include, for example, the instructions being executed by the processor(s) 1304). The instructions 1308 may also be referred to as program code or a computer program. The memory 1306 may also store data used by, and results computed by, the processor(s) 1304.

The STA 1302 may include one or more transceiver(s) 1310 that may include radio frequency (RF) transmitter circuitry and/or receiver circuitry that use the antenna(s) 1312 of the STA 1302 to facilitate signaling (e.g., the signaling 1334) to and/or from the STA 1302 with other devices (e.g., the AP 1318).

The STA 1302 may include one or more antenna(s) 1312 (e.g., one, two, four, or more). For embodiments with multiple antenna(s) 1312, the STA 1302 may leverage the spatial diversity of such multiple antenna(s) 1312 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the STA 1302 may be accomplished according to precoding (or digital beamforming) that is applied at the STA 1302 that multiplexes the data streams across the antenna(s) 1312 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the STA 1302 may implement analog beamforming techniques, whereby phases of the signals sent by the antenna(s) 1312 are relatively adjusted such that the (joint) transmission of the antenna(s) 1312 can be directed (this is sometimes referred to as beam steering).

The STA 1302 may include one or more interface(s) 1314. The interface(s) 1314 may be used to provide input to or output from the STA 1302. For example, a STA 1302 that is a UE may include interface(s) 1314 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1310/antenna(s) 1312 already described) that allow for communication between the UE and other devices and may operate according to known protocols (e.g., Wi-Fi®, Bluetooth®, and the like).

The STA 1302 may include an authenticator module 1316. The authenticator module 1316 may be implemented via hardware, software, or combinations thereof. For example, the authenticator module 1316 may be implemented as a processor, circuit, and/or instructions 1308 stored in the memory 1306 and executed by the processor(s) 1304. In some examples, the authenticator module 1316 may be integrated within the processor(s) 1304 and/or the transceiver(s) 1310. For example, the authenticator module 1316 may be implemented by a combination of software components (e.g., executed by a DSP or a general processor) and hardware components (e.g., logic gates and circuitry) within the processor(s) 1304 or the transceiver(s) 1310.

The authenticator module 1316 may be used for various aspects of the present disclosure, for example, aspects of FIGS. 5-12. The authenticator module 1316 is configured to authenticate the AP 1318 and provide the AP 1318 with authentication credentials.

The AP 1318 may include one or more processor(s) 1320. The processor(s) 1320 may execute instructions such that various operations of the AP 1318 are performed, as described herein. The processor(s) 1320 may include one or more baseband processors implemented using, for example, a CPU, a DSP, an ASIC, a controller, an FPGA device, another hardware device, a firmware device, or any combination thereof configured to perform the operations described herein.

The AP 1318 may include a memory 1322. The memory 1322 may be a non-transitory computer-readable storage medium that stores instructions 1324 (which may include, for example, the instructions being executed by the processor(s) 1320). The instructions 1324 may also be referred to as program code or a computer program. The memory 1322 may also store data used by, and results computed by, the processor(s) 1320.

The AP 1318 may include one or more transceiver(s) 1326 that may include RF transmitter circuitry and/or receiver circuitry that use the antenna(s) 1328 of the AP 1318 to facilitate signaling (e.g., the signaling 1334) to and/or from the AP 1318 with other devices (e.g., the STA 1302).

The AP 1318 may include one or more antenna(s) 1328 (e.g., one, two, four, or more). In embodiments having multiple antenna(s) 1328, the AP 1318 may perform MIMO, digital beamforming, analog beamforming, beam steering, etc., as has been described.

The AP 1318 may include one or more interface(s) 1330. The interface(s) 1330 may be used to provide input to or output from the AP 1318. For example, an AP 1318 that is a base station may include interface(s) 1330 made up of transmitters, receivers, and other circuitry (e.g., other than the transceiver(s) 1326/antenna(s) 1328 already described) that enables the base station to communicate with other equipment in a core network, and/or that enables the base station to communicate with external networks, computers, databases, and the like for purposes of operations, administration, and maintenance of the base station or other equipment operably connected thereto.

The AP 1318 may include an authenticator module 1332. The authenticator module 1332 may be implemented via hardware, software, or combinations thereof. For example, the authenticator module 1332 may be implemented as a processor, circuit, and/or instructions 1324 stored in the memory 1322 and executed by the processor(s) 1320. In some examples, the authenticator module 1332 may be integrated within the processor(s) 1320 and/or the transceiver(s) 1326. For example, the authenticator module 1332 may be implemented by a combination of software components (e.g., executed by a DSP or a general processor) and hardware components (e.g., logic gates and circuitry) within the processor(s) 1320 or the transceiver(s) 1326.

The authenticator module 1332 may be used for various aspects of the present disclosure, for example, aspects of FIGS. 5-12. The authenticator module 1332 is configured to authenticate the STA 1302 and provide the STA 1302 with authentication credentials.

For one or more embodiments, at least one of the components set forth in one or more of the preceding figures may be configured to perform one or more operations, techniques, processes, and/or methods as set forth herein. For example, a processor as described herein in connection with one or more of the preceding figures may be configured to operate in accordance with one or more of the examples set forth herein. For another example, circuitry associated with a STA or AP as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a station in a wireless local area network, the method comprising:
generating a Key Encryption Key (KEK) based on signaling with an access point;
receiving, from the access point, an inbound message comprising a modifier and an access point authentication credential that are both encrypted based on the KEK;
decrypting the modifier and the access point authentication credential based on the KEK; and
authenticating the access point by validating the access point authentication credential.

2. The method of claim 1, wherein the inbound message is an SAE confirm message.

3. The method of claim 1, further comprising:
generating a station authentication credential;
encrypting the station authentication credential based on the KEK; and
sending the station authentication credential to the access point.

4. The method of claim 1, wherein the access point authentication credential comprises at least one of an access point identifier, an authentication key, an access point authentication fingerprint, or any combination thereof.

5. The method of claim 1, wherein the access point authentication credential comprises a self-signed public key with a corresponding private key.

6. The method of claim 1, wherein the access point authentication credential comprises a self-signed certificate with a corresponding private key.

7. The method of claim 1, wherein the access point authentication credential comprises certificate signed by a root, with a root signing key pair.

8. The method of claim 1, wherein the access point authentication credential comprises a connector signed by a configurator with a configurator signing key pair.

9. A station apparatus comprising:
a processor; and
a memory storing instructions that, when executed by the processor, configure the apparatus to:
generate a Key Encryption Key (KEK) based on signaling with an access point;
receive, from the access point, an inbound message comprising a modifier and an access point authentication credential that are both encrypted based on the KEK;
decrypt the modifier and the access point authentication credential based on the KEK; and
authenticate the access point by validating the access point authentication credential.

10. The station apparatus of claim 9, wherein the inbound message is an SAE confirm message.

11. The station apparatus of claim 9, wherein the instructions further configure the apparatus to:
generate a station authentication credential;
encrypt the station authentication credential based on the KEK; and
send the station authentication credential to the access point.

12. The station apparatus of claim 9, wherein the access point authentication credential comprises at least one of an access point identifier, an authentication key, an access point authentication fingerprint, or any combination thereof.

13. The station apparatus of claim 9, wherein the access point authentication credential comprises a self-signed public key with a corresponding private key.

14. The station apparatus of claim 9, wherein the access point authentication credential comprises a self-signed certificate with a corresponding private key.

15. The station apparatus of claim 9, wherein the access point authentication credential comprises a certificate signed by a root, with a root sign key pair.

16. The station apparatus of claim 9, wherein the access point authentication credential comprises a connector signed by a configurator with a configurator sign key pair.

17. A method for an access point in a wireless local area network, the method comprising:
generating a Key Encryption Key (KEK) based on signaling with a station;
receiving, from the station, an inbound message comprising a station authentication credential that are both encrypted based on the KEK;
decrypting the station authentication credential based on the KEK; and
authenticating the station by validating the station authentication credential.

18. The method of claim 17, wherein the inbound message is an SAE confirm message.

19. The method of claim 17, further comprising:
generating an access point authentication credential;
encrypting the access point authentication credential based on the KEK; and
sending the access point authentication credential to the access point.

20. The method of claim 17, wherein the station authentication credential comprises at least one of an access point identifier or an authentication key.
